(19) United States
(12) Patent Application Publication
(10) Pub. No.: US 2008/0024557 A1
(43) Pub. Date: Jan. 31, 2008

(54) PRINTING ON A HEATED SUBSTRATE

(76) Inventor: Edward R. Moynihan, Plainfield, NH (US)

Correspondence Address: FISH & RICHARDSON PC, P.O. BOX 1022, MINNEAPOLIS, MN, 55440-1022, US

(21) Appl. No.: 11/460,068

(22) Filed: Jul. 26, 2006

(51) Int. Cl. B41J 2/05

(52) U.S. Cl. 347/56

(57) ABSTRACT

In general, an ink jet system including an ink jet printhead for printing solvent ink onto a substrate, and a heater positioned relative to the substrate sufficient for heating a substrate to a predetermined temperature to slow drop spread of the solvent ink.

### BACKGROUND

Droplet ejection devices are used for depositing droplets on a substrate. Ink jet printers are a type of droplet ejection device. Ink jet printers typically include an ink supply to a nozzle path. The nozzle path terminates in a nozzle opening from which ink drops are ejected. Ink drop ejection is controlled by pressurizing ink in the ink path with an actuator, which may be, for example, a piezoelectric deflector, a thermal bubble jet generator, or an electro statically deflected element. A typical printhead has an array of ink paths with corresponding nozzle openings and associated actuators, such that drop ejection from each nozzle opening can be independently controlled. In a drop-on-demand printhead, each actuator is fired to selectively eject a drop at a specific pixel location of an image as the printhead and a printing substrate are moved relative to one another. In high performance printheads, the nozzle openings typically have a diameter of 60 microns or less, e.g. around 35 microns, are separated at a pitch of 50-300 nozzle/inch, have a resolution of 100 to 3000 dpi or more, and provide drop sizes of about 1 to 100 picoliters. Drop ejection frequency can be 10 kHz or more.

Printing accuracy is influenced by a number of factors, including the size and velocity uniformity of drops ejected by the nozzles in the head and among multiple heads in a printer. The drop size and drop velocity uniformity are in turn influenced by factors such as the dimensional uniformity of the ink paths, acoustic interference effects, contamination in the ink flow paths, and the actuation uniformity of the actuators.

### SUMMARY

In an aspect, an ink jet system including an ink jet printhead for printing solvent ink onto a substrate, and a heater positioned relative to the substrate sufficient for heating a substrate to a predetermined temperature to slow drop spread of the solvent ink.

Implementations may include one or more of the following features. An ink jet system includes the heater positioned relative to the printhead. The solvent ink includes a solvent with a boiling point of about 308K to about 464K. The heater for heating a substrate heats the substrate to a temperature about ±25% of the boiling point of the solvent. An ink jet system can include a controller in electrical communication with the heater. The controller can store information on material properties of solvent inks and substrates. An ink jet system can also include a fan positioned relative to the substrate. The fan can electrically communicate with the controller. The heater can include a sensor for sensing temperature of the heater.

Other implementations can include one or more of the following features. An ink jet system can include a conveyor for moving a substrate relative to the printhead. The conveyor electrically communicates with the controller. The heater can include a platen, and the platen can include openings in communication with a vacuum source. The heater can be a radiant heat source, a cartridge heater, or a hot air source. The substrate can have a thermal conductivity of about 0.001 W/cmK or greater.

In another aspect, an ink jet system includes an ink jet printhead for printing a solvent ink onto a substrate, the solvent ink including a solvent having a boiling point; a heater positioned relative to the printhead and substrate for heating the substrate to about the boiling point of the solvent; and a controller in electrical communication with the heater for adjusting temperature of the heater.

In yet another aspect, a method of printing including heating a substrate to a predetermined temperature to slow drop spread of a solvent ink, and printing the solvent ink on the substrate.

Implementations may include one or more of the following features. The method of printing can include printing the solvent ink with an ink jet printer. The solvent ink can include a solvent having a boiling point (i.e., about 308K to about 464K), and heating the substrate to about the boiling point of the solvent (i.e., about ±25% of the boiling point of the solvent). The method of printing can include moving a substrate along a conveyor, sensing temperature of the heater, heating the substrate for about 15 seconds or less, heating the substrate with a cartridge heater, or heating the substrate with a radiant heat source.

Other implementations can also include one or more of the following features. The method can include heating the substrate prior to or after printing the solvent ink on the substrate, heating a substrate on a platen with openings in communication with a vacuum source, or adjusting the heating of the substrate.

The thermal properties of a material, the temperature of the material, and the boiling point of a solvent ink can affect the drop spread and image quality of an image printed on the material. Thermal properties of the substrate can include thermal mass, thermal diffusivity, and thermal conductivity, which is the product of its thermal mass and thermal diffusivity. The higher the thermal conductivity of the material, the quicker the material reaches the desired temperature.

The drop spread of solvent ink on a substrate depends on how quickly the solvent evaporates from the substrate. By heating the substrate close to the boiling point of the solvent, the solvent evaporates quickly causing the ink to spread less and improving the image quality.

Further aspects, features, and advantages will become apparent from the following detailed description, the drawings, and the claims.

### DESCRIPTION OF DRAWINGS

FIGS. 1a and 1b depict a printing system including a printhead and heater.

FIG. 2 depicts a heater used in a printing system.

FIG. 3a depicts a heated test sample printed with solvent ink.

FIG. 3b depicts a test sample printed with solvent ink at room temperature.

FIGS. 4a and 4b depict a printing system including a printhead and a radiant heat source.

### DETAILED DESCRIPTION

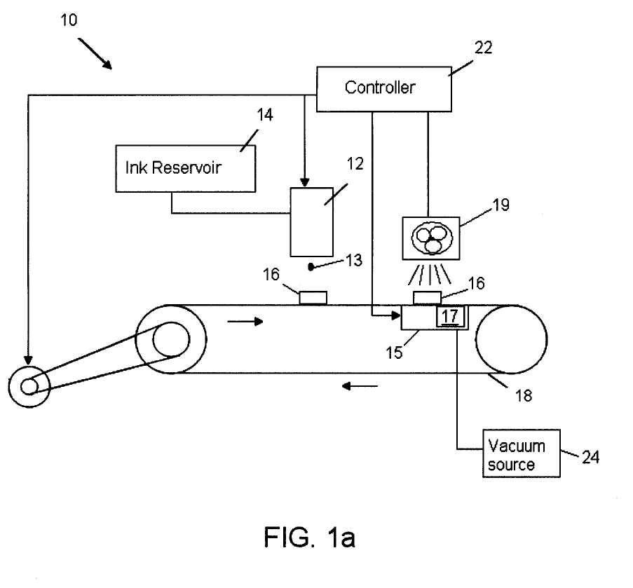

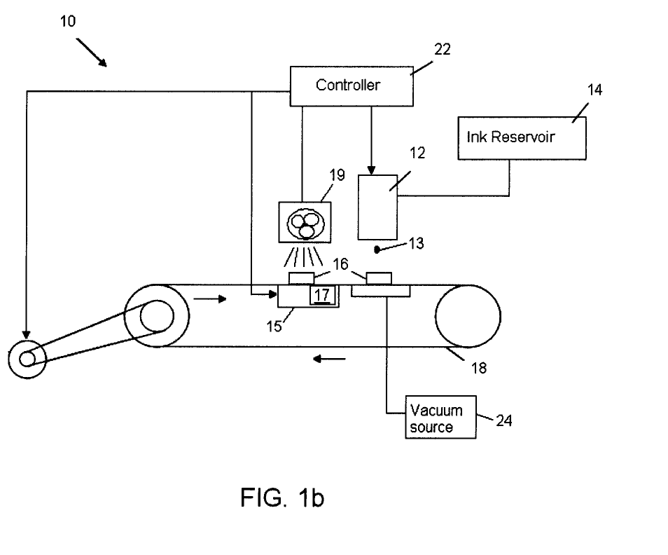

Referring to FIGS. 1a and 1b, a printing system 10 includes a printhead 12 for printing solvent ink 13 from ink reservoir 14 and a heater 15 for heating a substrate 16 after printing. In FIG. 1a, the substrate 16 moves along a conveyor 18, the printhead deposits solvent ink 13 on the substrate 16 as it travels past the printhead 12, and the heater 15 subsequently heats the substrate to slow the drop spread. A fan 19 blows air toward the substrate 16 while it is being heated, which forces the substrate against the heater for close contact. The blown air from fan 19 also carries away vapors that have evaporated from the solvent ink. The heater 15 has a platen with openings that communicate with a vacuum source 24, which also assists in a close contact between the heater 15 and substrate 16.

Alternatively, FIG. 1b shows the heater 15 heating the substrate prior to printing. The heater 15 is located a sufficient distance from the printhead 12, such that the solvent ink does not dry in the printhead nozzles. The fan 19 in FIG. 1b also blows air toward the substrate for a better contact with the heater. FIG. 1b shows a vacuum source 24 located beneath the printhead 12 to draw air through openings in the conveyor 18 and suction the substrate 16 to the conveyor 18. This provides a flat surface for printing and prevents the substrate from shifting during printing.

FIGS. 1a and 1b show a sensor 17 for detecting the temperature of the heater 15. The sensor 17 can provide feedback information to controller 22, such that the heater 15 can be controlled at a constant temperature or adjusted to a new temperature. The controller 22 can also control the rate of the conveyor 18 and send print information to the printhead 12. For example, the controller 22 may move the conveyor 18 at an increased rate when printing on a substrate with a high thermal conductivity and low thermal mass, or when printing with a solvent ink having a low boiling point, and vice versa.

The term “solvent ink” is used to describe ink that includes volatiles that evaporate. Solvent inks can be aqueous or nonaqueous. Typical solvents include water, alcohols, and methyl ethyl ketone (MEK). Pond, S., Ink Jet Technology and Product Development Strategies, p. 153-210, Torrey Pines Research (2000). Other solvents include ethyl lactate and N,N-dimethylpropionamide (DMPA). While some solvents can be highly toxic, ethyl lactate has relatively low toxicity and is considered biodegradable. Ethyl lactate can be used when printing on substrates contacting food products or pharmaceuticals. Ethyl lactate can be made from soy beans or corn. Solvent inks can also include volatile organic compounds (VOCs) as their main ingredient. The solvent weight percentages in solvent ink can be about 35 to 95 wt %. Solvent inks can be composed of many constituents, such as ink pigments, dyes, surfactants, and solvents.

The boiling point of the solvent (i.e., 35° C.-190° C., 308K-464K) in the solvent ink is used to determine the desired substrate temperature. For instance, the boiling points of water, methyl ethyl ketone, and ethyl lactate are 100° C., about 65° C., and about 151-155° C. respectively. The substrate is heated to a temperature close to the boiling point of the solvent (i.e., ±25%, ±10%, +10% to −25% of the solvent boiling point) so that the solvent quickly evaporates and slows the drop spread of the ink. For example, if solvents have boiling points in the range of about, 308K-464K, then the substrate can be heated to a temperature about ±25% of the solvent boiling point. If the boiling point of the solvent is about 338K, then the substrate can be heated to about 253K-423K. Other factors may affect how much the substrate is heated, such as other constituents in the ink and safety of the printing system for a user.

The thermal conductivity of a substrate influences the amount of heat and time needed to heat the substrate to a predetermined temperature. Thermal conductivity, k, is the ability of a material to conduct heat. When two thermal masses come in contact, the hotter mass is cooled while the cooler mass is heated. In this case, when the ink drop contacts the substrate, the ink is heated while the substrate is cooled. Thermal conductivity and thermal mass can be used to decide how long to heat a substrate. For instance, if a substrate has a high thermal conductivity and low thermal mass, then it takes less time to heat, and vice versa. In some applications, the substrate is heated for about 15 seconds or less (i.e., 10 seconds or less, 5 seconds or less, 1 second or less).

For example, a printhead can print a solvent ink that contains ethyl lactate onto a candy foil wrapper. Ethyl lactate has a boiling point of about 426K, and the foil wrapper made from aluminum has a thermal conductivity of about 2.2 W/cmK. Since the aluminum has a relatively high thermal conductivity and the foil wrapper has low thermal mass, the wrapper can be heated for only a few seconds close to the boiling point of the ethyl lactate (about 383K to 469K) to slow ink drop spread.

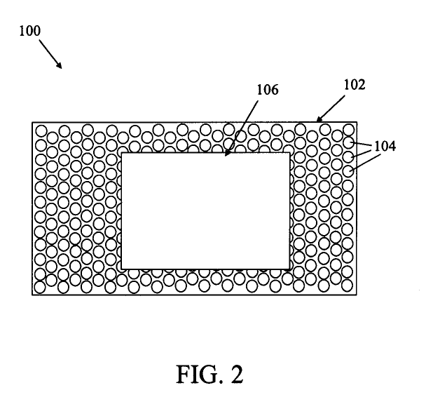

The controller 22 of the printing systems in FIGS. 1a and 1b can store information about different types of solvent inks, such as their boiling points, as well as information about different types of substrates, such as their thermal masses, thermal diffusivities, and thermal conductivities. The controller 22 can then communicate with the heater 15 to heat the substrate 16 to a predetermined temperature based on the type of solvent ink and substrate being used for the print job. Alternatively, a user can manually input the material properties of the ink and substrate to be printed. The heater 15 will then heat the substrate to the predetermined temperature based on the boiling point and thermal conductivity data stored in the controller. An example of heater 15 is shown in FIG. 2.

Referring to FIG. 2, the heater 100 includes a platen 102 with openings 104 formed through it, which can communicate with a vacuum source 24 as shown in FIG. 1a. Suctioning the substrate 106 to the platen 102 can efficiently and uniformly heat the substrate 106. The platen 102 can be made of any material that conducts heat, such as metal (i.e., aluminum) or ceramic. Alternatively, the platen 102 can be a solid surface without openings 104. Types of heaters can include a cartridge heater (available from Watlow Electric Manufacturing Company, St. Louis, Miss., USA), a radiant heat source (i.e., heat lamp), or a hot air source.

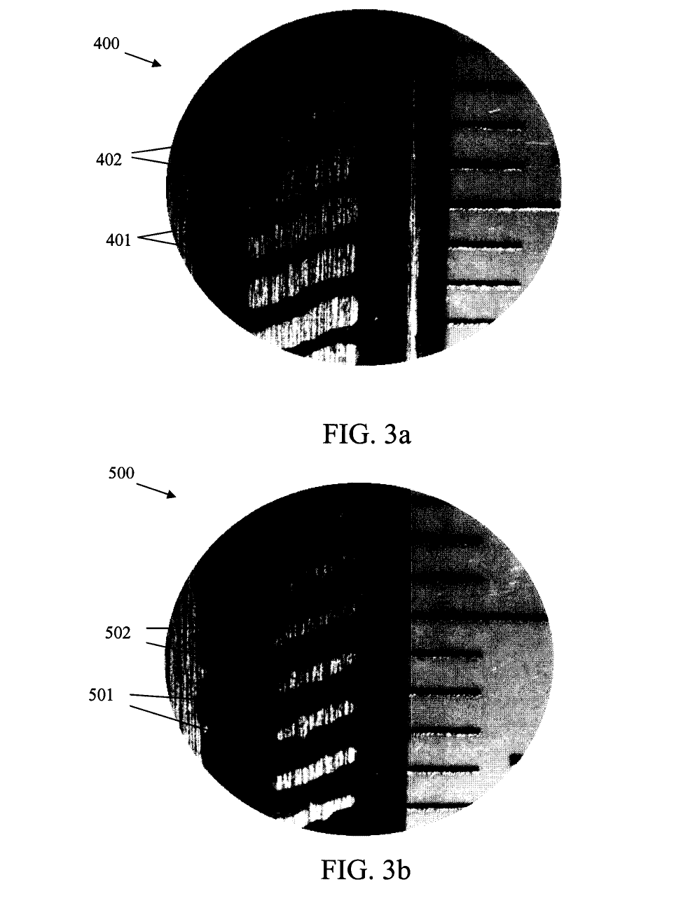

FIGS. 3a and 3b show photographs of print samples under a microscope at 20×magnification. The samples are nickel plated strips printed with a solvent food grade ink. In FIG. 3a, a nickel strip 400 heated to about 50-60° C. with a hot air gun shows printed areas 401 and unprinted areas 402. FIG. 3b shows a nickel strip 500 printed at room temperature with printed areas 501 and unprinted areas 502. The ruler on the right-hand side of the photos in FIGS. 3a and 3b has 1 mm divisions.

In FIG. 3b, the image quality is poor because of the increased amount of drop spread on the substrate. The spot diameter at room temperature was about 0.005 inch. The edges are blurry and not well defined, the ink flows into the unprinted areas 502. The distance between the unprinted areas 502 in FIG. 3b is greater than the distance between the unprinted areas 402 in the heated strip in FIG. 3a.

In contrast, the heated strip in FIG. 3a has better image quality with a spot diameter of about 0.002-0.0025 inch, half the spot diameter of the room temperature strip. The edges in FIG. 3a are more defined, and the ink does not flow into the unprinted areas as much as the room temperature strip in FIG. 3b. Heating the substrate slows the drop spread of the solvent ink and produces better image quality.

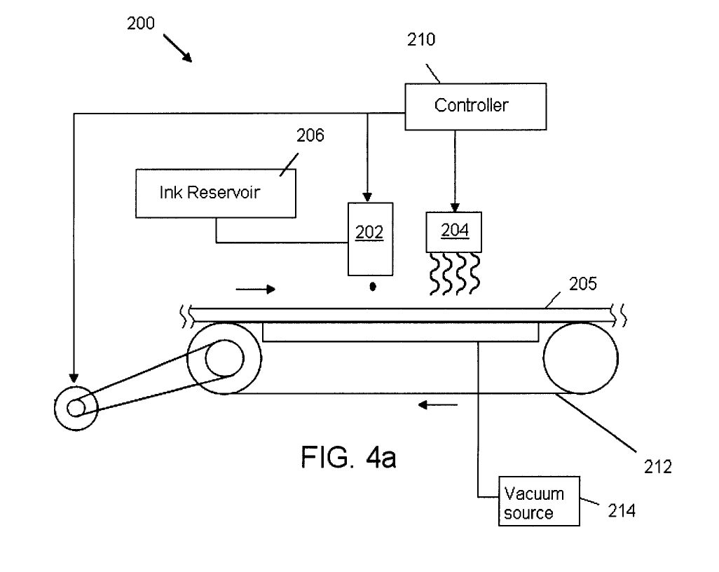

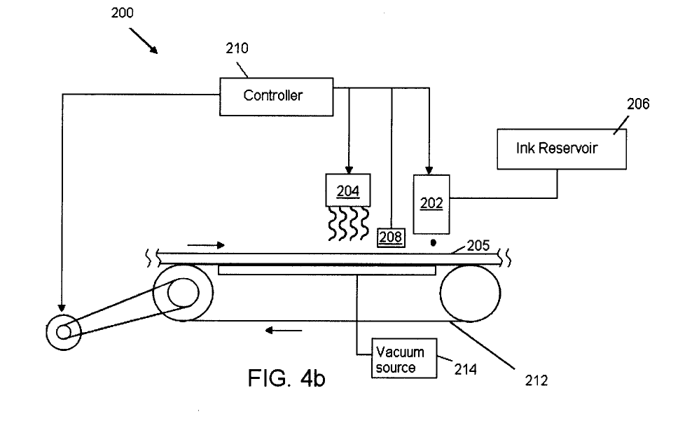

Referring to FIGS. 4a and 4b, a printing system 200 includes a printhead 202, a radiant heat source 204 for heating a substrate (i.e., web) 205 before or after printing, an ink reservoir 206 to supply ink to the printhead 202, and a controller 210 electrically communicating with the conveyor 212, printhead 202, and radiant heat source 204. The conveyor 212 can have openings in communication with a vacuum source 214 to suction the web 205 to the conveyor. This helps with printing and heating the web.

The printing system in FIG. 4b also includes a sensor 208 above the conveyor 212 to detect the temperature of the web 205 after heating. The sensor 208 sends the temperature reading to the controller 210. The controller 210 can use the temperature reading to passively monitor whether the web is heated to a controlled temperature, or to actively monitor whether the web has reached a predetermined temperature and is ready to be printed. The controller 210 can use this temperature reading to adjust the temperature of the heater. The controller 210 can also use the temperature reading to move the conveyor 212 if the web 205 has reached a desired temperature.

The radiant heat source 204 can also be useful when printing on nonplanar substrates that do not lie flat on a platen (i.e, ball) because a platen heat source may not be able to heat the top surface quickly. The radiant heat source can localize heat to a particular area on the nonplanar substrate and quickly heat the area.

Platen heat sources can also be used to heat nonplanar substrates, and radiant heat sources can be used to heat planar substrates. Radiant heat sources can include infrared and incandescent light.

Referring back to FIGS. 1a, 1b, 4a, and 4b, a printing system can optionally include or exclude some of the features shown. The features can also be arranged in different configurations. For example, a printing system can include more sensors or exclude the controller. The printheads, fans, sensors and heaters can be located in different positions, such as below the substrate, above the substrate, or next to the substrate.

The substrates in FIGS. 1a, 1b, 4a, and 4b can be discrete objects or a continuous web, planar or nonplanar, symmetrical or asymmetrical. Substrates can be made of any material or combination of materials, such as paper, vinyl, metal, wood, glass, or plastic. Thermal conductivities of substrates include about 0.001 W/cmK to 0.0015 W/cmK for paper and vinyl, about 0.002 W/cmK to 0.007 W/cmK for fibre-reinforced plastic, about 0.0033 W/cmK to 0.0052 W/cmK for high-density polymers, about 0.008 W/cmK to 0.0093 W/cmK for glass, and about 0.14 W/cmK to 4.29 W/cmK for various metals. For more information about thermal conductivity, see the CRC Handbook of Chemistry and Physics and Young, Hugh D., University Physics, 7th Ed. Table 15-5.

Printheads for a printing system are available from Dimatix, Inc., Lebanon, N.H., USA, such as Nova JA 256/80 AAA.

Other implementations and combinations of these implementations are within the scope of the following claims.

What is claimed is:

1. An ink jet system comprising:
an ink jet printhead for printing solvent ink onto a substrate; and
a heater positioned relative to the substrate sufficient for heating a substrate to a predetermined temperature to slow drop spread of the solvent ink.

2. The ink jet system of claim 1, wherein the heater is positioned relative to the printhead.

3. The ink jet system of claim 1, wherein the solvent ink comprises a solvent with a boiling point of about 308K to about 464K.

4. The ink jet system of claim 3, wherein the heater for heating a substrate heats the substrate to a temperature about ±25% of the boiling point of the solvent.

5. The ink jet system of claim 1, further comprising a controller in electrical communication with the heater.

6. The ink jet system of claim 5, wherein the controller stores information on material properties of solvent inks and substrates.

7. The ink jet system of claim 5, further comprising a fan positioned relative to the substrate.

8. The ink jet system of claim 7, wherein the fan electrically communicates with the controller.

9. The ink jet system of claim 1, wherein the heater includes a sensor for sensing temperature of the heater.

10. The ink jet system of claim 5, further comprising a conveyor for moving a substrate relative to the printhead.

11. The ink jet system of claim 10, wherein the conveyor electrically communicates with the controller.

12. The ink jet system of claim 1, wherein the heater includes a platen.

13. The ink jet system of claim 12, wherein the platen includes openings in communication with a vacuum source.

14. The ink jet system of claim 1, wherein the heater is a radiant heat source.

15. The ink jet system of claim 1, wherein the heater is a cartridge heater.

16. The ink jet system of claim 1, wherein the heater is a hot air source.

17. An ink jet system of claim 1, wherein the substrate has a thermal conductivity of about 0.001 W/cmK or greater.

18. An ink jet system comprising:
an ink jet printhead for printing a solvent ink onto a substrate, the solvent ink comprising a solvent having a boiling point;
a heater positioned relative to the printhead and substrate for heating the substrate to about the boiling point of the solvent; and
a controller in electrical communication with the heater for adjusting temperature of the heater.

19. A method of printing comprising:
heating a substrate to a predetermined temperature to slow drop spread of a solvent ink; and
printing the solvent ink on the substrate.

20. The method of claim 19, further comprising printing the solvent ink with an ink jet printer.

21. The method of claim 19, wherein the solvent ink comprising a solvent having a boiling point, and heating the substrate to about the boiling point of the solvent.

22. The method of claim 21, wherein the boiling point of the solvent is about 308K to about 464K.

23. The method of claim 22, wherein heating the substrate to about ±25% of the boiling point of the solvent.

24. The method of claim 19, further comprising moving a substrate along a conveyor.

25. The method of claim 17, further comprising sensing temperature of the heater.

26. The method of claim 19, further comprising heating the substrate for about 15 seconds or less.

27. The method of claim 19, further comprising heating the substrate with a cartridge heater.

28. The method of claim 19, further comprising heating the substrate with a radiant heat source.

29. The method of claim 19, further comprising heating the substrate prior to printing the solvent ink on the substrate.

30. The method of claim 19, further comprising heating the substrate after printing the solvent ink on the substrate.

31. The method of claim 19, further comprising heating a substrate on a platen with openings in communication with a vacuum source.

32. The method of claim 19, further comprising adjusting the heating of the heater.
